(19) United States
(12) Patent Application Publication
(10) Pub. No.: US 2024/0413686 A1
(43) Pub. Date: Dec. 12, 2024

(54) Brushless Electric Machine and Method of Manufacturing the Brushless Electric Machine

(71) Applicant: Robert Bosch GmbH, Stuttgart (DE)

(72) Inventors: Simon Mensak, Ludwigsburg (DE); Robert Bonasewicz, Mt. Prospect, IL (US)

(21) Appl. No.: 18/733,549

(22) Filed: Jun. 4, 2024

(30) Foreign Application Priority Data
Jun. 7, 2023 (DE) 10 2023 205 335.7

(51) Int. Cl. H02K 1/28; H02K 1/278; H02K 7/14; H02K 15/03; H02K 21/16

(52) U.S. Cl. CPC H02K 1/28; H02K 1/278; H02K 7/145; H02K 15/03; H02K 21/16

(57) ABSTRACT

A brushless electric machine, in particular a brushless DC motor, has a stator and a rotor arranged within the stator so as to be rotatable relative thereto. The rotor has a cylindrical base body which is non-rotatably connected to a machine shaft and carries a plurality of permanent magnets on its outer circumference, and the stator has a stator winding with a plurality of single-tooth windings for driving the rotor via an electrically generated magnetic field. The permanent magnets of the rotor are fixed by a thin-walled reinforcement radially surrounding them, wherein the reinforcement is connected to the permanent magnets by a plurality of welding points in a materially and/or positively locking manner.

This application claims priority under 35 U.S.C. § 119 to application no. DE 10 2023 205 335.7, filed on Jun. 7, 2023 in Germany, the disclosure of which is incorporated herein by reference in its entirety.

The disclosure relates to a brushless electric machine, in particular a brushless DC motor, having a stator and a rotor which is arranged within the stator so as to be rotatable relative thereto, wherein the rotor has a cylindrical base body which is connected to a machine shaft in a rotationally fixed manner and which carries a plurality of permanent magnets on its outer circumference, and wherein the stator has a stator winding with a plurality of single-tooth windings for driving the rotor by means of an electrically generated magnetic field. In addition, the disclosure relates to a method for manufacturing a brushless electric machine.

### BACKGROUND

A brushless electric machine is to be understood in particular as an electric machine with a three-phase winding on the stator side, which can be controlled or regulated in such a way that a rotating magnetic field is generated, which pulls along a permanently excited rotor. Alternatively, it is also conceivable to use the rotor in conjunction with a generator.

Rotors for brushless electric machines, in particular brushless direct current machines-known as BLDC (brushless direct current) or EC (electronically commutated) machines for short—with permanently excited magnets are generally manufactured in two different versions. On the one hand, the permanent magnets of different polarity can be buried in so-called pockets of a hollow cylindrical base body, on the other hand, it is possible to apply the magnets or a correspondingly alternately polarized magnetic ring from the outside as surface magnets on the base body. The base body usually consists of a large number of rotor laminations stacked to form a rotor laminated core, each of which has been punched out of a soft magnetic sheet. However, other designs of rotors for electric machines, in particular for EC machines, are also conceivable. For example, the hollow cylindrical base body of the rotor can be made of composite materials (soft magnetic composites-SMC). SMC materials consist of high-purity iron powder with a specific surface coating on each individual particle. This electrically insulating surface ensures a high electrical resistance even after pressing and heat treatment, which in turn minimizes or avoids eddy current losses. SMC materials are known to the specialist, so that their composition will not be discussed further here.

The permanent magnets of the magnetic ring consist in particular of a hard magnetic material, for example an iron, cobalt or nickel alloy. If the permanent magnets are designed as surface magnets, they can be magnetized either before or after mounting on the rotor. Plastic-bonded permanent magnets whose magnetic powder is embedded in a matrix of plastic binder are also conceivable. The magnetic powder can, for example, consist of hard ferrite, SmCo and/or NdFeB or be designed as an AlNiCo alloy. Preferably, the plastic binder is a thermoplastic binder, for example made of polyamide or polyphenyl sulfide. Alternatively, it is also conceivable that the plastic binder is designed as a thermosetting binder, for example as an epoxy resin.

In addition to their numerous advantages over buried magnets, surface magnets have the disadvantage of lower mechanical strength against centrifugal forces that act on the surface magnets during operation of the electric machine. In addition to the mechanical strength of the surface magnets, their attachment to the base body also plays an important role in preventing defects and failures.

DE 11 2016 004 207 T5 discloses a rotor for an electric machine that has a rotor core, a plurality of permanent magnets, a conductive element and a holding element. The permanent magnets are formed on an outer peripheral area of the rotor core and are arranged at a distance from each other in the circumferential direction via pole gaps. The conductivity of the conductive element is higher than the conductivity of the permanent magnets. It surrounds the rotor core and the plurality of permanent magnets as a whole and has first and second opposing areas that face each other via a gap in the circumferential direction. Finally, the holding element surrounds the rotor core, the plurality of permanent magnets and the conductive element as a whole.

It is an object of the disclosure to provide a brushless electric machine whose permanent magnets arranged on the outer circumference of the rotor are held by an improved reinforcement compared to the prior art, wherein the reinforcement is also particularly securely connected to the permanent magnets to prevent defects and failures.

### SUMMARY

To solve this problem, the permanent magnets of the rotor are fixed by means of a thin-walled reinforcement radially surrounding them, wherein the reinforcement is connected to the permanent magnets by a plurality of welding points in a material and/or form-fitting manner. In a particularly advantageous way, the electric machine in general and the rotor in particular can be protected efficiently and cost-effectively against damage even at very high speeds of more than 20,000 rpm (rotations per minute). In addition, the thin-walled reinforcement allows a small gap between the rotor and stator, so that the electric machine can be designed in such a way that its efficiency losses are minimized.

The disclosure also relates to a processing device driven by an electric motor, in particular a hand-held electric machine tool, with a brushless electric machine according to the disclosure. In the context of the disclosure, a processing device driven by an electric motor is to be understood as, inter alia, battery-operated and/or mains-powered machine tools for processing workpieces by means of an insert tool driven by a brushless electric motor. The electrical machining device can be designed not only as a hand-held power tool, but also as a stationary machine tool. Typical machine tools in this context include hand-held or stationary drills, screwdrivers, impact drills, planers, angular grinders, oscillating sanders, polishing machines, or the like. However, electric appliances also include suitably powered garden and construction equipment such as lawn mowers, lawn trimmers, branch saws, motorized and trenchers, blowers, robot breakers and excavators and the like. Furthermore, the disclosure is applicable to brushless electric motors of household appliances, such as vacuum cleaners, mixers, etc.

In a further development, it is provided that the reinforcement is designed as at least one hollow cylindrical sleeve, wherein the number, shape and distribution of the welding points are dependent on the operating parameters of the brushless electric machine and/or the sleeve. For example, a number of 1 to 10, in particular 2 to 4, welding points can be provided for each permanent magnet. The number of spot welds depends on the dimensions of the rotor, in particular its diameter and length, as well as the size and shape of the permanent magnets. The number of spot welds should be kept as low as possible to prevent interference with the magnetic flux between the rotor and stator. On the other hand, a certain minimum number is required to securely fix the reinforcement or sleeve. In addition to optimizing the number of spot welds, their size or shape can also be varied so that they each have a diameter of approx. 0.2 to 2 mm. The number, shape and distribution of the spot welds can also be used to compensate for any imbalance in the rotor.

The welding points are particularly preferably arranged in the circumferential direction of the rotor in the center of the permanent magnets and/or near or above a pole gap between two adjacent permanent magnets. This ensures the best possible contact between the reinforcement or sleeve and the permanent magnets without impairing the efficiency of the electric machine.

The at least one sleeve can be provided with a seam that runs essentially perpendicular to a longitudinal axis of the machine shaft of the brushless DC machine. In contrast to a seamless sleeve, a seam allows a simpler manufacturing process for the sleeve. The reinforcement can also consist of a plurality of sleeves that are pushed onto the permanent magnets. The individual sleeves of the reinforcement can be pushed onto the permanent magnets mounted on the rotor one after the other from one direction or, particularly in the case of an even number of sleeves, in pairs from both directions along the longitudinal axis of the machine shaft.

In a further design, it is provided that the reinforcement consists of a paramagnetic metal, in particular aluminum, brass, stainless steel or the like. Alternatively, the reinforcement can also consist of a plastic with a permeability index of a maximum of 15, in particular a maximum of 2, or of a composite material formed from the plastic and the paramagnetic metal. Paramagnetic metals are metals whose permeability number is greater than 1, which are not strongly attracted by a magnet and which are not magnetizable themselves. Paramagnetic metals therefore differ significantly in their magnetic properties from ferromagnetic metals, such as iron, and diamagnetic metals, such as copper. It should be noted at this point that the term a magnetic is sometimes also used for paramagnetic or non-ferromagnetic materials. Strictly speaking, however, there are no non-magnetic materials, as all materials react magnetically above a certain intensity of the magnetic field to which they are exposed. With particular advantage, a reinforcement consisting of a paramagnetic metal and/or a plastic with a low permeability number prevents a partial or complete short circuit of the magnetic circuit of the brushless electric motor.

To make it easier to slide the at least one sleeve onto the permanent magnets of the rotor, it has an insertion phase at one open end that widens in relation to its inner diameter, the inner diameter of which is larger than an outer diameter of the rotor with the mounted permanent magnets.

The disclosure also relates to a method for manufacturing the brushless electric machine, wherein the reinforcement is pushed onto the permanent magnets of the rotor in the direction of a longitudinal axis of the machine shaft and then welded to the permanent magnets by means of a laser, in particular a laser of a mounting device, in a material-locking and/or form-locking manner. The laser is used to briefly heat a focal point so that a melting column is created, which softens or liquefies parts of the reinforcement and the permanent magnets in such a way that, after solidification, an undercut and/or a protrusion is created between them, which causes the form fit. In a further process step, the reinforcement is friction-locked to the permanent magnets by means of a longitudinal press connection before welding. The reinforcement is irreversibly plastically deformed during the longitudinal press connection by expanding its internal diameter.

### BRIEF DESCRIPTION OF THE DRAWINGS

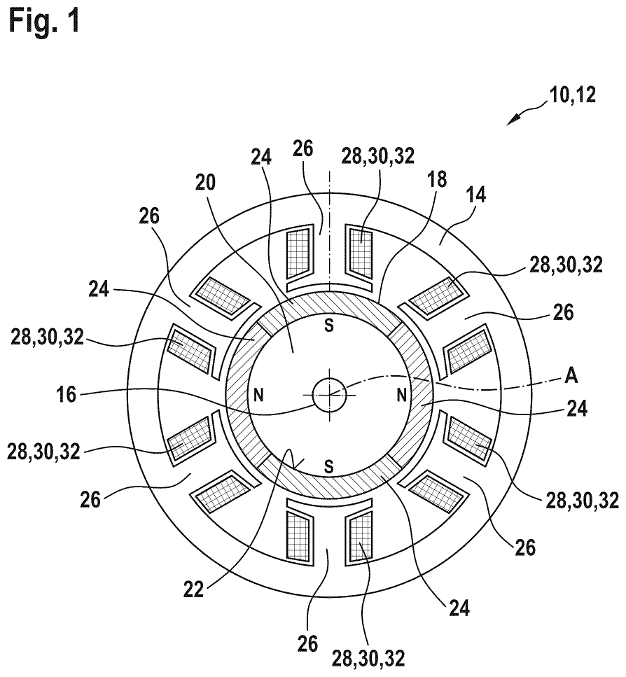

The disclosure is explained below with reference to FIGS. 1 through 11 by way of example, wherein identical reference numbers in the drawings indicate identical components having an identical function.

### Shown are:

FIG. 1: a cross-sectional view of a three-phase brushless electric machine according to the prior art,

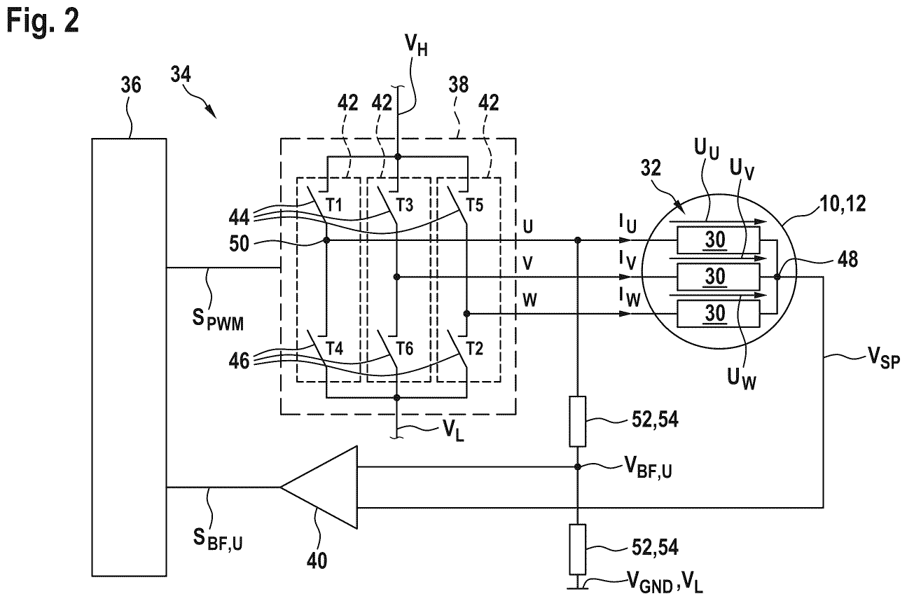

FIG. 2: a block diagram of an electronic circuit for controlling the electric machine designed as a brushless DC motor according to FIG. 1,

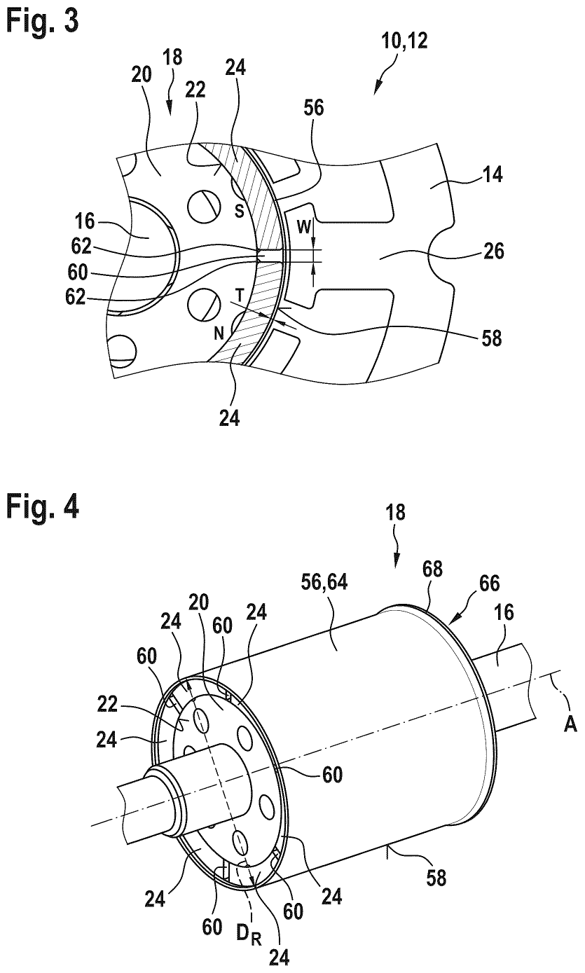

FIG. 3: a sectional view of a first embodiment example of the brushless electric machine according to the disclosure,

FIG. 4: a second embodiment example of the rotor of the brushless electric machine according to the disclosure in a perspective view,

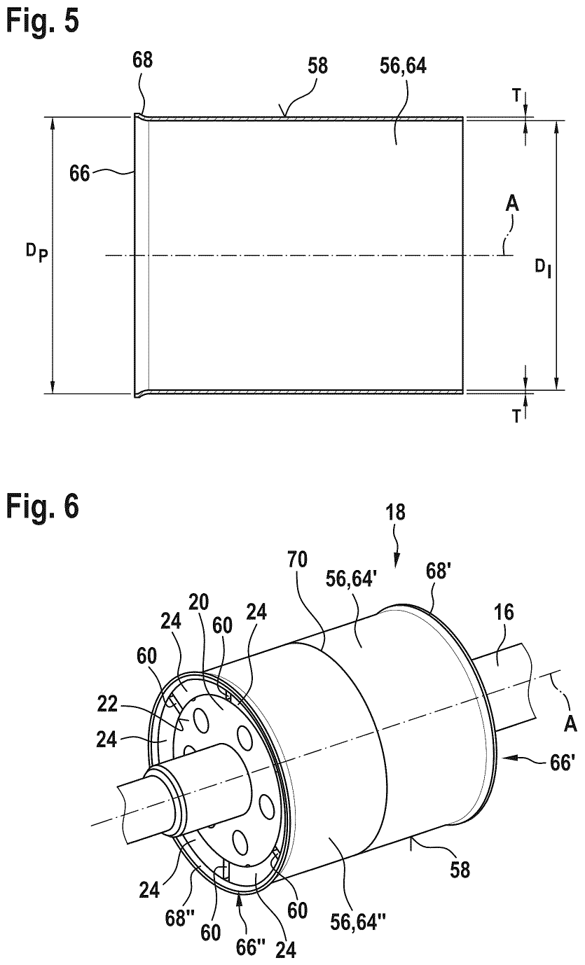

FIG. 5: a section through the sleeve according to the disclosure for fixing the permanent magnets of the rotor according to FIG. 4,

FIG. 6: a third embodiment example of the rotor of the brushless electric machine according to the disclosure in a perspective view,

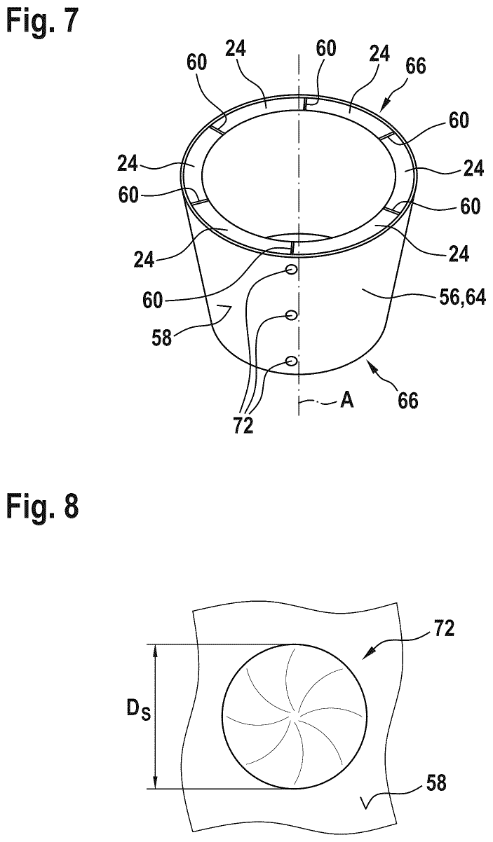

FIG. 7: a perspective view of a first embodiment example for connecting the sleeve according to the disclosure to the permanent magnets,

FIG. 8: a top view of an embodiment example of a single spot weld as shown in FIG. 7,

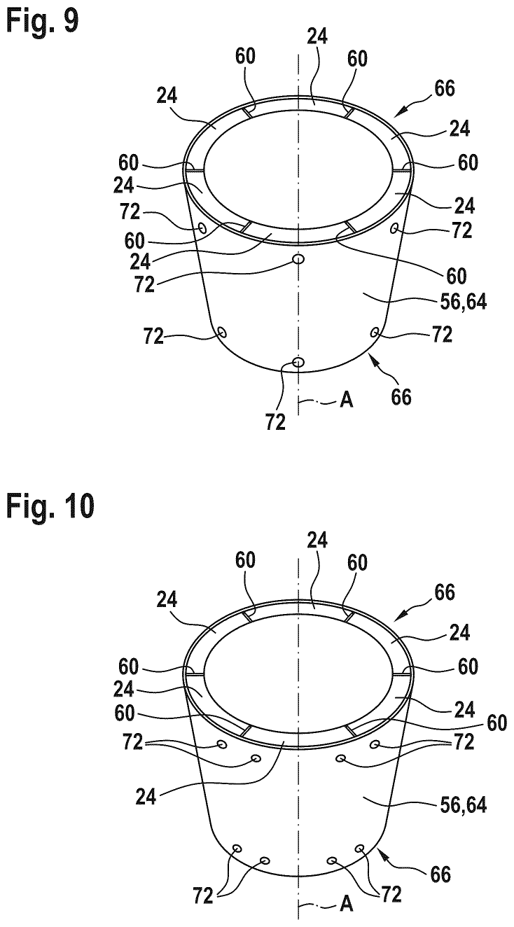

FIG. 9: a second embodiment example for connecting the sleeve according to the disclosure to the permanent magnets in a perspective view,

FIG. 10: a third embodiment example for connecting the sleeve according to the disclosure to the permanent magnets in a perspective view and

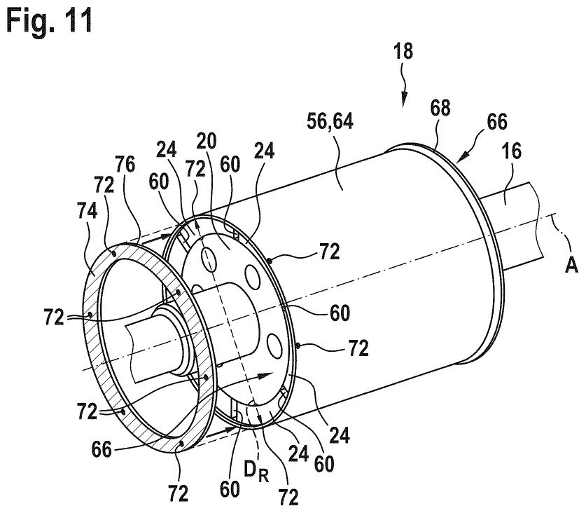

FIG. 11: a fourth embodiment example for connecting the sleeve according to the disclosure to the permanent magnets in a perspective view.

### DETAILED DESCRIPTION

FIG. 1 shows a cross-section of a brushless electric machine 10 according to the prior art, which is designed as a three-phase brushless direct current motor (BLDC or EC motor) 12 with a stator 14 and a rotor 18 arranged fixed in rotation on a machine shaft 16. The brushless DC motor 12 is used to drive a processing device not shown in detail, such as a vacuum cleaner, a machine tool or similar. Instead of a BLDC or EC motor 12, an alternating current motor (AC motor), for example in the form of an asynchronous or synchronous motor, can also be considered. The rotor 18 of the brushless DC motor 12 comprises a cylindrical base body 20, which has on its outer circumference 22 a plurality of permanent magnets 24 designed as surface magnets, which alternate in their polarity N, S in the circumferential direction of the rotor 18. In the embodiment example, four permanent magnets 24 are shown, which in turn form two rotor pole pairs. However, a different number of permanent magnets 24 is also conceivable. The stator 14 has six radially inwardly directed stator teeth 26, each of which in turn carries a single-tooth winding 28, wherein in each case two opposing single-tooth windings 28 form a winding strand 30 of a three-phase stator winding 32. With its stator teeth 26, the stator 14 defines a cylindrical cavity in which the rotor 18 is arranged so that it can rotate relative to the stator 14 by means of the machine shaft 16. When current flows through the winding strands 30, they generate a rotating magnetic field, which sets the permanently excited rotor 18 and the machine shaft 16 in a rotary motion. As a precaution, it should be noted that the following disclosure is not only applicable to a brushless electric machine 10 designed as an electric motor. The brushless electric motor 10 can also be designed as an appropriately constructed generator. In the following, however, the disclosure will only be described with reference to the brushless DC motor 12.

FIG. 2 shows a device 34 for controlling the brushless DC motor 12 as shown in FIG. 1. In addition to the brushless DC motor 12, the device 34 comprises a control or regulating unit 36, a driver circuit 38 and a comparator 40. For the sake of clarity, only the most important components and assemblies of the device 34 are shown. The control or regulating unit 36 can be designed as a microprocessor (μP), a digital signal processor (DSP), an application-specific integrated circuit (ASIC) or the like. It is also conceivable that the control or regulating unit 36 consists at least partially of discrete semiconductor components. The driver circuit 38 is designed as an inverter in the form of a B6 bridge circuit and has a half-bridge 42 designed as an inverter circuit for each phase or winding 30 of the three phases U, V, W of the stator winding 32. Each half bridge 42 consists of a first circuit breaker 44, which is connected to a high supply potential V_{H} (high side), and a second circuit breaker 46, which is connected to a low supply potential V_{L} (low side). The power switches 44, 46 can be designed as semiconductor switches in the form of IGBTs, IGCTs, thyristors, power MOSFETs or the like, but also as relays. The control or regulating unit 36 controls the individual circuit breakers 44, 46 for energizing two winding strings 30 in each case by means of a pulse-width modulated signal or a plurality of pulse-width modulated signals S_{PWM} (both are to be used here as synonyms) in such a way that the first circuit breaker 44 of one of the three half-bridges 42 is closed (e.g. T1), while the first power switches 44 of the other two half-bridges 42 are open (e.g. T3 and T5), and that at least the second power switch 46 of one of the other two half-bridges 42 is closed (e.g. T2), while the second power switch 46 of at least that half-bridge 42 whose first power switch 44 (e.g. T1) is closed is open (e.g. T4). In this way, the first circuit breakers 44 and the second circuit breakers 46 can be switched alternately to generate the rotating magnetic field in such a way that four of the six single-tooth windings 28 of the winding strings 30 are energized, so that during operation the resulting stator flux is oriented on average perpendicular to the rotor flux. In addition, to avoid short circuits, it is ensured that both circuit-breakers 44, 46 of the same half-bridge 42 are never closed at the same time (e.g. T1 and T4). For this purpose, the circuit-breakers 44, 46 of the same half-bridge 42 are always closed with a certain dead time after the opening of the respective other circuit-breaker 44, 46 by means of the pulse-width modulated signal S_{PWM}. The person skilled in the art is familiar with this type of wiring, so that it will not be discussed further here. Instead of a plurality of B6 half bridges, H bridges or comparable inverter circuits can also be used to control the individual phases U, V, W of the brushless DC motor 12.

In order to be able to determine the exact switching times for the individual circuit-breakers 44, 46 of the driver circuit 38, the position of the rotor 18 must be known to the control unit 36. The rotor position can be determined, for example, by means of sensors, e.g. Hall sensors, which are arranged around the circumference of the rotor 18 on the stator 14. Instead of using sensors to determine the rotor position, however, it is often advantageous to determine it without sensors via the back EMF in conjunction with electrical commutation, as this generally results in lower costs due to the elimination of sensors and greater reliability in conjunction with a more compact design of the brushless electric motor 10. When using the back EMF, the course of a voltage induced in a currentless winding 28 by the permanent magnets 24 of the rotor 18 is detected. In the prior art, the zero crossing of a phase current I_{U}, I_{V}, I_{W} of one of the phases U, V, W is first predicted and the energization of the corresponding winding phase 30 is interrupted for a predetermined period of time, in which the predicted zero crossing lies, by means of the pulse-width modulated signal S_{PWM}. After the phase voltage U_{U}, U_{V}, U_{W} of the relevant phase U, V, W is switched off, the associated phase current I_{U}, I_{V} [/g9], I_{W} flows via a freewheeling element, not shown, which is connected in parallel with the switched-off circuit-breaker 44, 46. In the case of a MOSFET, for example, the freewheeling element is realized by its intrinsic freewheeling diode. As the freewheeling diode only conducts in one direction, the voltage rises sharply as soon as the phase current I_{U}, I_{V}, I_{W} through the relevant winding 30 reaches zero. This means that the zero crossing of the phase current I_{U}, I_{V}, I_{W} can be determined after the phase voltage U_{U}, U_{V}, U_{W} is switched off and the phase shift between the phase current I_{U}, I_{V}, I_{W} and the back EMF can be calculated to detect the position of the rotor 18.

In the embodiment example shown in FIG. 2, only the phase U is used to detect the rotor position. For this purpose, the comparator 40 forms an arithmetic difference U_{Diff} between a potential V_{SP} of a common star point 48 of the winding strands 30 of the brushless DC motor 12 applied to a first input and a potential V_{BF,U} of a node 50 applied to a second input for energizing the respective winding strand 30 of phase U. To determine the potential V_{BF,U} of the voltage induced in the unenergized winding phase 30, a voltage divider 54 formed from at least two resistors 52 is used, which on the one hand is connected to the node 50 and on the other hand is at a reference potential V_{GND}, the low supply potential V_{L} or a comparable reference potential. The arithmetic difference U_{Diff} is then transferred as a digitized back-EMF signal S_{BF,U} from the comparator 40 to the control or regulation unit 36.

FIG. 3 illustrates a sectional view of the brushless DC motor 12 transverse to the longitudinal axis A of the machine shaft 16. According to FIG. 1, the base body 20 of the rotor 18, which is non-rotatably connected to the machine shaft 16, carries the permanent magnets 24 with alternating polarities N, S on its outer circumference 22. The permanent magnets 24 are connected to the base body 20 in a material, form-fitting and/or force-fitting manner and are also fixed by means of a thin-walled reinforcement 56 radially surrounding them. To ensure that the permanent magnets 24 are securely fixed even at very high speeds of the brushless DC motor 12 of more than 20,000 rpm and also that the magnetic gap between rotor 18 and stator 14 can be kept as small as possible to maintain or increase efficiency, the reinforcement 56 has a modulus of elasticity of at least 150 GPa and/or a yield strength of at least 600 MPa. A very low deformation can be achieved by a high modulus of elasticity despite the low wall thickness, while a high yield strength prevents unwanted plastic deformation on an outer circumference 58 of the reinforcement 56.

In order to prevent a partial or complete short circuit of the magnetic circuit of the brushless electric motor 12, the reinforcement 56 consists of a paramagnetic metal, in particular aluminum, brass, stainless steel or the like. Alternatively, the reinforcement 56 can also consist of a plastic with a permeability index μᵣ of maximum 15, in particular of maximum 2, or of a composite material formed from the plastic and the paramagnetic metal.

A pole gap 60 is provided between each of two adjacent permanent magnets 24 mounted on the base body 20 of the rotor 18. For form-fitting or force-fitting attachment of the permanent magnets 24, the base body 20 of the rotor 18 has projections 62 distributed over its outer circumference 22, by means of which the preferably still non-magnetized permanent magnets 24 can be positioned with the defined pole pieces 60. These projections 58 can, for example, be formed as nubs, webs or the like on the base body 20. Alternatively or additionally, the permanent magnets 24 can also be bonded to the base body 20, for example by means of adhesive bonding. The pole gaps 60 allow optimization both with regard to the power density of the brushless DC motor 12 and with regard to the utilization of the magnetic material used in the permanent magnets 24. Thus, depending on requirements, a compromise between the costs and the efficiency of the brushless DC motor 12 can be achieved in a simple manner by keeping the pole gaps 60 as small as possible on the one hand in order not to reduce the power density of the brushless DC motor 12 or to reduce it only minimally, and on the other hand by designing them so large that the magnetic material used can be utilized in the best possible way. For this purpose, the ratio between a width W of the pole gap 60 in the circumferential direction and an outer diameter D_{R} of the rotor 18 provided with the permanent magnets 24 (cf. FIG. 4) is preferably less than 10%. In this context, a thin-walled reinforcement 56 should preferably be understood to mean that a thickness T of the reinforcement 56 is less than 2% of its inner diameter D_{I}.

To manufacture the brushless DC motor 12 according to the disclosure, in a first process step a plurality of initially non-magnetized or weakly magnetized permanent magnets 24 are mounted on the outer circumference 22 of the base body 20 of the rotor 18, in particular by means of a mounting device not shown in detail, in such a way that a pole gap 60 remains between each two adjacent permanent magnets 24. The permanent magnets 24 can be attached to the base body in a material-, form- and/or force-locking manner as described above. In a subsequent process step, the reinforcement 56 is pushed onto the permanent magnets 24 of the rotor 18 in the direction of the longitudinal axis A of the machine shaft 16. This can also preferably be automated by the mounting device. In the course of the pushing-on process, the reinforcement 56 is connected to the permanent magnets 24 via a force-fit longitudinal press-fit connection in such a way that the reinforcement 56 is plastically irreversibly deformed by an expansion of its internal diameter D_{I} (see FIG. 5). Before the rotor 18 is inserted into the stator 14, the permanent magnets 56 are magnetized in a further process step by means of at least one magnetization coil of the mounting device.

The pole gaps 60 between two adjacent permanent magnets 24 provide the advantage of simple, subsequent and, above all, complete magnetization of the initially non-magnetized or weakly magnetized permanent magnets 24. Complete magnetization results in a significantly higher magnetic flux, so that the permanent magnets 24 also make a significant contribution to the torque generation of the brushless DC motor 12 in their peripheral areas. In addition, the non-magnetized or weakly magnetized permanent magnets 24 can be positioned more easily and more precisely over the outer circumference 22 of the base body 20 of the rotor 18, as they do not exert any magnetic attraction, or at least only a slight one.

FIG. 4 shows a further embodiment example of the rotor 18 in a perspective view. The reinforcement 56 is designed as a hollow cylindrical sleeve 64, which is frictionally connected to the permanent magnets 24 of the rotor 18 by means of a longitudinal press-fit connection. The sleeve 64 is plastically irreversibly deformed during the longitudinal press-fit connection by expanding its internal diameter D_{I}. While the reinforcement 56 according to FIG. 3 can also be designed as a ring, for example, which only extends over part of the length of the base body 20 of the rotor 18, the sleeve 64 completely encases the permanent magnets 24. The sleeve 64 thus extends in the direction of the longitudinal axis A of the machine shaft 16 over the entire length of the base body 20 of the rotor 18. At an open end 66, the sleeve 64 has an insertion phase 68 which widens in relation to its inner diameter D_{I} and whose inner diameter D_{P} is larger than an outer diameter D_{R} of the rotor 18 with the mounted permanent magnets 24. This makes it easier to slide the sleeve 64 along the longitudinal axis A of the machine shaft 16.

For clarification, the thin-walled sleeve 64 of thickness T, which has not yet been pushed onto the rotor 18, is shown in FIG. 5 in a section along the longitudinal axis A. It can be seen that the inner diameter D_{P} of the insertion phase 68 at the open end 66 of the sleeve 64 is larger than the inner diameter D_{I} of its hollow cylindrical part. In order to achieve the longitudinal press-fit connection while the sleeve 64 is being pushed on, the inside diameter D_{I} of its hollow cylindrical part must be smaller than the outside diameter D_{R} of the base body 20 of the rotor 18 provided with the permanent magnets 24 when it is not pushed on. The relationship D_{P}>D_{R}>D_{I} therefore applies when sleeve 64 is remounted. In addition, a correspondingly high yield strength of the sleeve 64 of at least 600 MPa can prevent unwanted plastic deformation on its outer circumference 58 during operation of the brushless DC motor 12. On the one hand, this enables a very small magnetic gap between rotor 18 and stator 14 without the risk of mechanical contact and, on the other hand, ensures the concentricity of rotor 18 even at very high speeds.

FIG. 6 shows a further design in which the reinforcement 56 is formed from two sleeves 64′, 64″, which are joined together by means of a seam 70 extending substantially perpendicular to the longitudinal axis A of the machine shaft 16. In contrast to the seamless sleeve 64 shown in FIGS. 4 and 5, the seam 70 permits a simpler manufacturing and mounting process for the sleeves 64′, 64″, in particular in the case of a particularly elongated base body 20 of the rotor 18. The sleeves 64′, 64″ can be joined, in particular welded, by means of the seam 70 before being pushed onto the permanent magnets 24 in such a way that they each have an insertion phase 68′, 68″ at their open ends 66′, 66″ after joining. Alternatively, it is also conceivable that the individual sleeves 64′, 64″ of the reinforcement 56 are pushed onto the permanent magnets 24 mounted on the base body 20 of the rotor 18 one after the other from one direction or, in particular in the case of an even number of sleeves 64, in pairs from both directions along the longitudinal axis A of the machine shaft 16 and then joined with a material bond by means of the seam 70. If the sleeves 64′, 64″ are made of a plastic or a composite material, the seam 70 connecting them can also be produced by laser welding or the like. Bonding the seam 70 is also conceivable.

FIG. 7 shows a perspective view of a first embodiment example for connecting the reinforcement 56, which is designed as a sleeve 64, to the permanent magnets 24. For illustrative purposes, the basic body 20 and the machine shaft 16 of the rotor 18 are not shown. However, it should be noted that the permanent magnets 24—as described above—are already mounted on the base body 20 of the rotor 18 before the sleeve 64 is slid on, while maintaining the pole gaps 60 provided between them. The sleeve 64, which consists in particular of a paramagnetic metal, is connected to the permanent magnets 24 by a plurality of welding points 72 in a materially and/or positively locking manner. In a particularly advantageous manner, the welding points 72 can be set automatically after the sleeve 64 has been pushed onto the permanent magnets 24 using a corresponding, but not shown in detail, welding device, in particular a laser, of the assembly device. Manual setting of the spot welds 72 is also conceivable. As a result, the brushless DC motor 12 in general and its rotor 18 in particular can be efficiently and cost-effectively protected against damage, for example due to deformation and/or axial displacement of the sleeve 64 along the longitudinal axis A of the machine shaft 16, even at very high speeds of more than 20,000 rpm and in the event of impacts, falls or the like.

Depending on the operating parameters of the brushless DC motor 12 and/or the sleeve 64, the number, shape and distribution of the spot welds can vary. The number of spot welds 72, for example, should be as large as possible or as small as necessary to securely fix the sleeve 64, but also as small as possible or as large as necessary to prevent interference with the magnetic flux between the rotor 18 and the stator 14. According to FIG. 7, three spot welds 72 are provided along the longitudinal axis A in the area of the pole pieces 60—two of the spot welds 72 near the open ends 66 and a third essentially halfway along the length of the sleeve 64. In the case of a longer or shorter sleeve 64, more or fewer spot welds 72 can be provided accordingly. Depending on the outer diameter D_{R} of the rotor 18 and the number of permanent magnets 24 or pole pieces 60, it is also possible not to provide the welding points 72 in the vicinity of each pole piece 60, but to leave out individual pole pieces 60. However, it is advantageous if the number of welding points 72 per permanent magnet 24 is in the range from 1 to 10, in particular from 2 to 4, wherein—as mentioned—this depends largely on the dimensions of the rotor 18 and the number, size and shape of the permanent magnets 24.

FIG. 8 shows a single spot weld 72 in a plan view. In addition to a material connection, the laser can also be used to create a positive connection by briefly heating a focal point so that a melting column is created, which softens or liquefies parts of the sleeve 64 and the permanent magnet 24. After solidification of the molten column, an undercut and/or a projection is formed between the sleeve 64 and the permanent magnet 24, which causes the form fit. In addition to optimizing the number of spot welds 72, their size or shape can alternatively or additionally be varied in such a way that they each have a diameter D_{S} of approximately 0.2 to 2 mm. Both the sleeve 64 and the permanent magnets 24 must be made of materials that can be welded together to form a tight connection. In the case of the sleeve 64, this is ensured in particular by a paramagnetic metal, wherein plastics and composite materials also exist that are suitable for welding to the permanent magnets 24. The material of the permanent magnets 24 should preferably be sintered or hot-pressed. However, plastic-bonded permanent magnets 24 can also be used here. The same applies to any coatings and coatings of sleeves 64 and permanent magnets 24. The number, shape and distribution of the spot welds 72 can also be used to compensate, within limits, for any imbalance of the rotor 18, so that the spot welds 72 do not necessarily have to be arranged symmetrically around the outer circumference 58 of the sleeve 64.

FIG. 9 shows a perspective view of a second embodiment example for the material and/or form-fit connection of the sleeve 64 and the permanent magnets 24 by means of a plurality of spot welds 72. In contrast to FIG. 8, two spot welds 72 are arranged along the longitudinal axis A essentially in the circumferential direction of the sleeve 64 in the center above the individual permanent magnets 24. The spot welds 72 are located near the two open ends 66 of the sleeve 64. However, it is also conceivable that even more spot welds can be arranged along the longitudinal axis A depending on the length of the sleeve 64. It is also conceivable that with a smaller outer diameter D_{R} of the rotor 18, not every permanent magnet 24 is positively and/or non-positively connected to the sleeve 64 via the welding points 72.

A third embodiment example for connecting the sleeve 64 and the permanent magnets 24 by means of a plurality of spot welds 72 is shown in FIG. 10. Four welding points 72 are provided for each permanent magnet 24 in such a way that they are located near the two open ends 66 of the sleeve 64 in edge areas of the permanent magnets 24 near the pole pieces 60.

FIG. 11 shows a fourth embodiment example for connecting the sleeve 64 and the permanent magnets 24. After the sleeve 64 has been pushed on, a ring 74 is attached to one of its open ends 66, in particular to the open end 66 opposite the open end 66 with the insertion phase 68, in such a way that it is connected to the permanent magnets 24 at the end face and to the sleeve 64 at its circumferential edge 76 via a plurality of welding points 72. A welding point 72 can be provided for permanent magnet 24. However, depending on the outer diameter D_{R} of the rotor 18 and the number of permanent magnets 24, more or fewer spot welds 72 are also conceivable. Preferably, the ring 74 is made of the same material as the sleeve 64. It is also possible to provide a ring 74 at each open end 66 of the sleeve 64. Instead of a ring 74, the sleeve 64 can also have individual tabs on at least one of its open ends 66, which are bent over after being pushed onto the permanent magnets 24 and welded to the end face of the permanent magnet 24.

Finally, it should be pointed out that the disclosure is not limited to the embodiment examples shown in FIGS. 3 through 11, but that these are to be understood as exemplary. In particular, the number, shape and size of the permanent magnets 24 can vary. The size of the rotor 18 shown in the figures and the design of the stator 14 of the brushless DC motor 12 are also not to be understood as limiting. This also applies to the brushless DC motor 12 and the electronics that control it, which would have to be adapted accordingly in the case of a brushless electric motor 10 designed as a generator.

1. A brushless electric machine comprising:
a stator having a stator winding with a plurality of single-tooth windings; and
a rotor arranged within the stator so as to be rotatable relative thereto, the rotor having a cylindrical base body which is connected to a machine shaft in a rotationally fixed manner and which carries a plurality of permanent magnets on its outer circumference, and
wherein the plurality of single-tooth windings are configured to drive the rotor via an electrically generated magnetic field, and
wherein the plurality of permanent magnets of the rotor are fixed via a thin-walled reinforcement radially surrounding the plurality of permanent magnets, the reinforcement being connected to the permanent magnets in a materially and/or positively locking manner via a plurality of welding points.

2. The brushless electric machine according to claim 1, wherein:
the reinforcement includes at least one hollow cylindrical sleeve, and
a number, shape and distribution of the welding points is dependent on operating parameters of the brushless electric machine and/or the hollow cylindrical sleeve.

3. The brushless electric machine according to claim 1, wherein the plurality of welding points includes from 1 to 10 welding points for each permanent magnet of the plurality of permanent magnets.

4. The brushless electric machine according to claim 1, wherein each of the plurality of welding points has a diameter of approximately 0.2 to 2 mm.

5. The brushless electric machine according to claim 1, wherein each of the plurality of welding points is arranged in a center of one of the plurality of permanent magnets relative to a circumferential direction of the rotor and/or close to or above a pole gap between two adjacent permanent magnets of the plurality of permanent magnets.

6. The brushless electric machine according to claim 2, wherein the at least one hollow cylindrical sleeve has a seam which runs essentially perpendicular to a longitudinal axis of the machine shaft.

7. The brushless electric machine according to claim 1, wherein the reinforcement consists of a paramagnetic metal.

8. The brushless electric machine according to claim 1, wherein the reinforcement consists of a plastic with a permeability number of at most 15 or of a composite material formed from the plastic and a paramagnetic metal.

9. The brushless electric machine according to claim 2, wherein the at least one hollow cylindrical sleeve has, at an open end, an insertion phase which widens with respect to an inside diameter of the sleeve, the insertion phase having an inside diameter that is larger than an outside diameter of the rotor with the mounted permanent magnets.

10. An electric motor-driven processing device comprising:
the brushless electric machine according to claim 1.

11. A method for manufacturing the brushless electric machine according to claim 1, the method comprising:
pushing the reinforcement onto the plurality of permanent magnets in a direction of a longitudinal axis of the machine shaft; and
welding the reinforcement to the permanent magnets with a welding device in a material-locking and/or form-locking manner.

12. The method according to claim 11, wherein the welding comprises:
briefly heating a focal point with the welding device so that a melting column is formed, which softens or liquefies parts of the reinforcement and the permanent magnets in such a way that, after the reinforcement and the plurality of permanent magnets have solidified, an undercut and/or a projection is formed between the reinforcement and the plurality of permanent magnets, which causes a form fit.

13. The method according to claim 11, wherein the pushing of the reinforcement comprises:
non-positively connecting the reinforcement to the permanent magnets with a longitudinal press connection before the welding.

14. The method according to claim 13, wherein the reinforcement is plastically irreversibly deformed during the longitudinal press connection by an expansion of an internal diameter of the reinforcement.

15. The brushless electric machine according to claim 1, wherein the brushless electric machine is a brushless DC motor.

16. The brushless electric machine according to claim 3, wherein the plurality of welding points includes from 2 to 4 welding points for each permanent magnet of the plurality of permanent magnets.

17. The brushless electric machine according to claim 7, wherein the reinforcement comprises aluminum, brass, stainless steel, or the like.

18. The brushless electric machine according to claim 8, wherein the permeability number of the plastic is at most 2.

19. The electric motor-driven processing device according to claim 10, wherein the electric motor-driven processing device is a hand-held electric machine tool.

20. The method of claim 11, wherein the welding device is a laser of a mounting device.
